(19) United States
(12) Patent Application Publication
(10) Pub. No.: US 2015/0048118 A1
(43) Pub. Date: Feb. 19, 2015

(54) COOLER WITH RESERVOIR

(71) Applicants: Edward A. ENGLISH, Birmingham, AL (US); Mark A. ENGLISH, Birmingham, AL (US)

(72) Inventors: Edward A. ENGLISH, Birmingham, AL (US); Mark A. ENGLISH, Birmingham, AL (US)

(21) Appl. No.: 14/458,842

(22) Filed: Aug. 13, 2014

Related U.S. Application Data
(60) Provisional application No. 61/865,410, filed on Aug. 13, 2013.

(51) Int. Cl. B67D 3/00; B67D 3/04

(52) U.S. Cl. CPC B67D 3/0029; B67D 3/0083; B67D 3/04
USPC 222/181.1; 222/183; 222/556

(57) ABSTRACT

The present invention discloses a reservoir which can be used on its own or inside of an insulated cooler to dispense liquids. The reservoir generally comprises a lid for retention of liquid and at least one opening in one vertical wall which is used to connect to a conduit which connects to a horizontally, non-gravity mounted coupling. The coupling connects to another conduit which connects to a spigot. The reservoir has a flat bottom surface, which allows for it to stand alone, outside of the insulated cooler if desired. The reservoir may also be placed inside the insulated cooler and in that case, the conduit connected to the spigot threads through one of the insulated cooler's walls to connect to the spigot to allow the flow of liquid to the exterior of the cooler.

### STATEMENT REGARDING PRIORITY

This application claims the benefit of the filing date of U.S. Provisional patent application No. 61/865,410 filed on Aug. 13, 2013, Cooler with Reservoir (currently pending), the entire contents of which is incorporated herein by reference.

### FIELD OF THE INVENTION

The present invention is in the field of coolers and dispensers of beverages and other liquids.

### BACKGROUND OF THE INVENTION

Various approaches to dispensing liquids have been attempted and are known in the prior art, but none has enabled the use of a flat bottom reservoir that is easy to handle and easy to install and remove from an insulated shell, which allows for dispensing of the liquid by way of a spigot from either the insulated shell or directly from the flat bottom reservoir sitting on any flat surface. Beverage or liquid dispensers are known in the prior art, as illustrated by U.S. Pat. App. No. 2007/0277547A1 to Veeravagu et al., which discloses a beverage dispensing apparatus for holding both containerized and non-containerized beverages, which includes an internal container that is secured to the insulated cooler by two separate methods. First, the internal container is secured to the insulated cooler by a vertical coupling method connecting the bottom of the interior container to the inside of the insulated cooler. This approach, however, does not address the portability and stability of the interior container when removed from the insulated cooler, because the vertical coupling prohibits placing the interior container upright on a flat surface without a method of stabilizing the container such as legs or other support structures.

The approach of the Veeravagu interior container stabilization raises the center of gravity, making the container more unstable and inhibits the container from being easily stored to preserve the liquid contents when it is not connected to the insulated cooler. The vertical coupling on the bottom of the internal container creates many issues with handling the container, its stability, and storage. Second, the internal container has a separate means of securing the stability of the interior cooler on its front exterior wall which connects to the interior wall of the insulated cooler (elements 14 and 16). Accordingly, Veeravagu requires two methods of vertical stabilization and does not contemplate or allow for a horizontal connection.

U.S. Pat. No. 5,222,631 to Hood et. al. discloses a removable liquid container for insulated coolers, which allows the dispensing of liquid from a separate interior container without opening the outer insulated container. The removable liquid container is connected inside the insulated cooler by way of a vertical coupling. This approach does not provide for removal and storage of the interior container. The vertical connection does not allow for the removable liquid container to be used outside of the insulated cooler at all. Hood does not provide for a horizontal coupling because of an embodiment with a bottle adapter cap used in an embodiment where the removable liquid container is a soft drink bottle and the regular bottle cap is replaced with a bottle adapter cap, which must be connected vertically to allow the flow of liquid from the bottle through the bottle adapter cap and then through the wall of the insulated cooler and to the exterior of the insulated cooler.

What is needed is a container inside the interior of an insulated cooler using a coupling mechanism which allows for a non-gravity mounted connection in a horizontal position. This connection allows the bottom of the internal container to remain flat, which in turn allows the internal container to be easily removed from the insulated container and used on its own as a liquid dispenser when desired.

### BRIEF DESCRIPTION OF THE DRAWINGS

FIG. 1 is a partial sectional view of the shell containing the removable reservoir with a non-gravity mounted, horizontally oriented coupling, two conduits and spigot of one embodiment of the invention, wherein the male and female ends of the coupling are not joined.

FIG. 1A is a plan view of the shell comprising an opening through a wall of said shell and through which the first conduit may extend.

FIG. 1B is a plan view of the reservoir comprising an opening through a wall of said reservoir by which the liquid in the reservoir may flow through to the second conduit.

FIG. 2 is a top partial sectional view of the shell containing the removable reservoir with the embodiment of the non-gravity mounted, horizontally oriented coupling, two conduits and spigot of one embodiment of the invention.

FIG. 3 is an exterior side view of the embodiment of the reservoir with conduit, attached coupling and spigot resting on a horizontal surface when separated from the shell.

FIGS. 4A & 4B show an end view of the mouth of the movable ring-clamp in the unengaged (4A) and engaged (4B) positions in the embodiment with the movable ring clamp on the female end of the non-gravity mounted coupling.

### DETAILED DESCRIPTION OF THE INVENTION

The present invention comprises a cooler with a reservoir adapted for installation in and removal from an insulated shell, and providing an improved means for dispensing liquid from the reservoir without opening the shell, when the reservoir is mounted within the shell. When the reservoir is removed from the shell, the reservoir may be used to dispense beverages on any substantially flat surface without any support.

The reservoir is suitable for storage and use as a liquid dispenser independent of the shell. A horizontally aligned, non-gravity mounted coupling provides for simplified attachment and detachment of the reservoir to and from the shell.

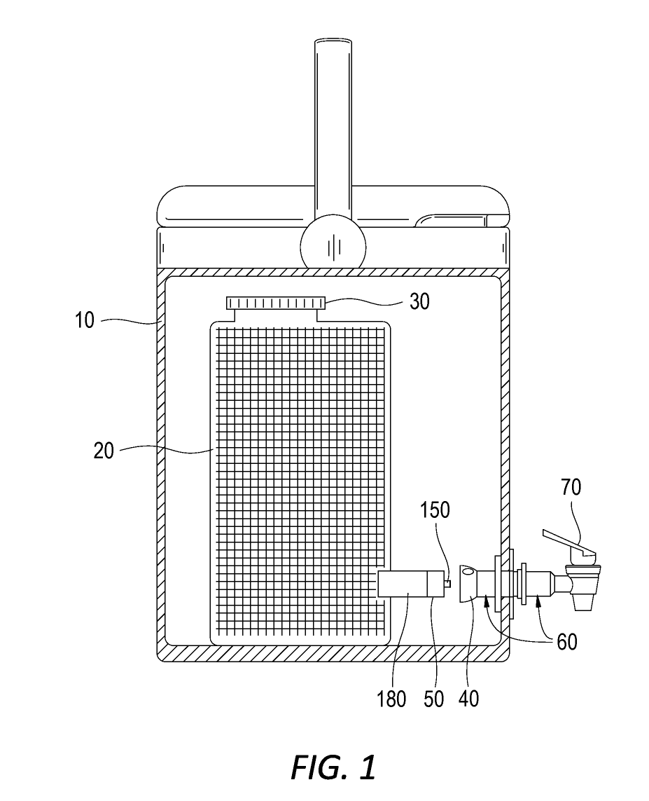

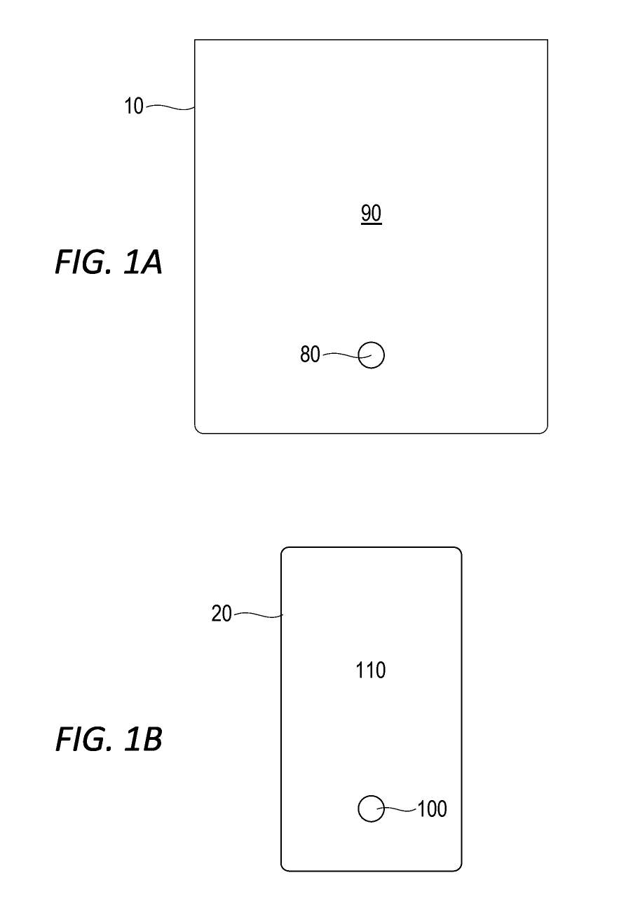

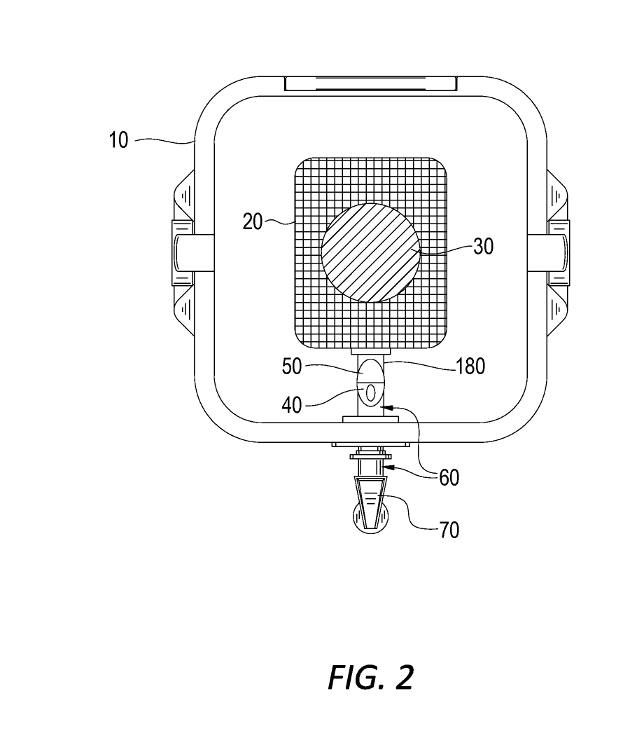

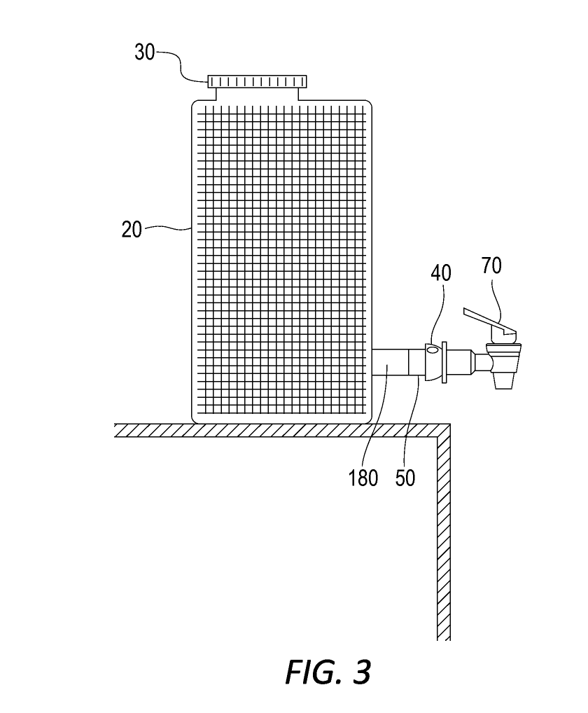

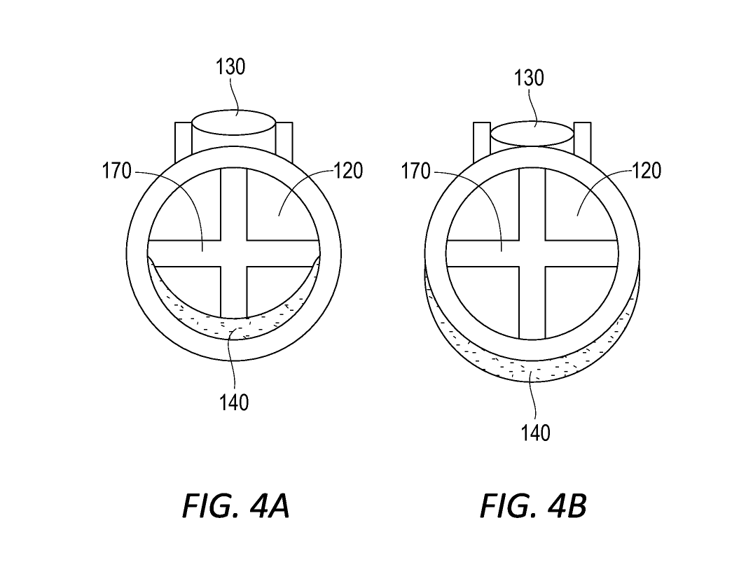

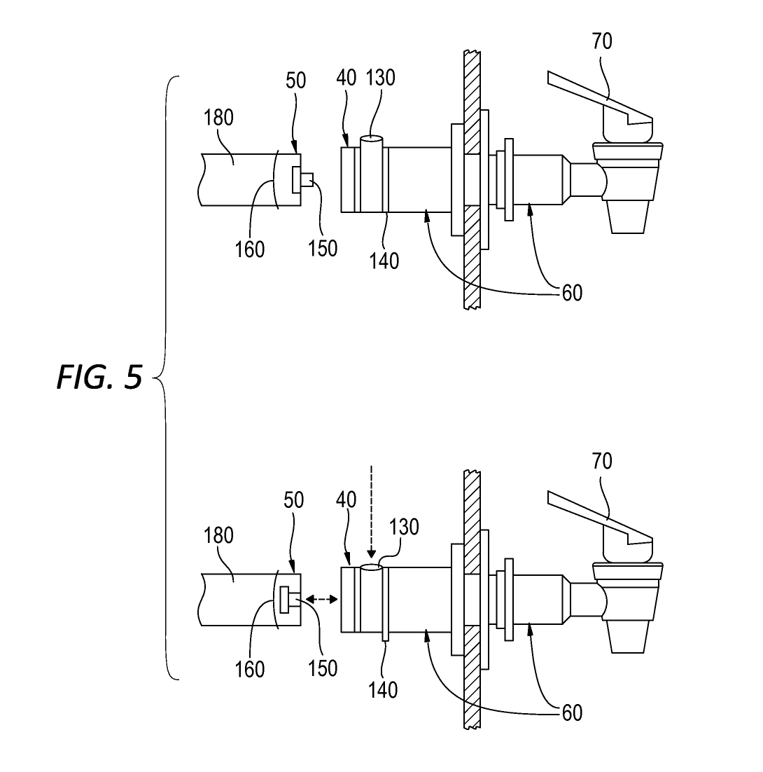

Referring now to the invention in more detail, FIGS. 1-5, show the shell, reservoir, first and second conduits, and coupling constructed according to one embodiment of the invention. The unit includes a shell 10 dimensionally configured to accommodate a reservoir 20 and additional space determined to be sufficient for the addition of ice or other means of cooling the liquid contents of the reservoir 20. The shell 10 may be adaptably sized proportionally to accommodate various sizes and quantities of the reservoir 20, that is, there may be more than one reservoir in the shell each reservoir with an opening to the outside and connecting to its own conduit and opening to the outside. For each reservoir 20, the shell 10 is further modified with an opening 80 through a wall 90 of said shell through which a first conduit 60 may be threaded and attached.

One embodiment of the reservoir 20 is designed to rest upon its substantially flat exterior bottom for vertical stability when placed upon the horizontally-oriented, bottom interior surface of the shell 10 and otherwise may be in various size and design configurations appropriate for inclusion in the interior space available within the shell 10. Likewise, the exterior bottom surface of the reservoir 20 is designed for maintaining vertical stability on other horizontal surfaces outside of the insulated shell 10 without need of additional devices, legs, stands, or props. The reservoir 20 has a lid 30 for retention of liquid as may be poured into the reservoir 20. The reservoir 20 has at least one opening 100 in one vertical wall 110 which is spaced and sized to horizontally align with the opening in the wall 90 of the shell 10 with the second conduit 180 attached. Also, the opening in the vertical wall 110 of the reservoir 20 is proportionally sized to the opening provided through, in one embodiment, the male end of the non-gravity mounted coupling 50 opposite the female end of the non-gravity mounted coupling 40.

The interior bottom of the shell is flat so as to allow the reservoir to sit in the shell without the need for special means for securing the reservoir within the shell. The coupling between the first and second conduits will allow some movement of the reservoir relative to the shell. The longer the first and second conduits, the more potential movement. The conduits may be comprised of rigid plastic or any other similar material. Relative movement of the reservoir helps prevent stress on the coupling. In another embodiment of the invention, the first and second conduits are comprised of flexible material to allow for additional relative movement of the reservoir within the shell.

Another embodiment of the reservoir is a flexible, collapsible bladder having no definite structure and also comprising a re-sealable, liquid-tight top, and at least one opening in the bladder which is spaced and sized to horizontally align with the second conduit 180, which connects to the male end of the non-gravity mounted coupling 50 opposite the female end of the non-gravity mounted coupling 40.

The first conduit 60 extends from the exterior of the shell 10 through an opening 80 where the first conduit connects to the spigot 70 to the interior of the shell 10 where it connects to the female end of the non-gravity mounted coupling 40. Attached to the opening in the vertical wall of the reservoir 20 is a second conduit which is connected to the male end of a non-gravity mounted coupling 50 comprising a pin 150, which is spring loaded. The male end of the non-gravity mounted coupling 50 opposite of the end used for the coupling assembly connected to the second conduit which is attached to the reservoir 20 through various mechanical or chemical methods. In one embodiment, a pin 150 at the male end of the coupling 50 is biased by a spring to a closed position when uncoupled from the female end of the non-gravity mounted coupling 40. The reservoir 20, when attached to the shell or not, can be filled with liquid while sitting upon a horizontal surface without leakage of the liquid. Further, the reservoir 20 with attached lid 30 and the attached male end of the non-gravity mounted coupling 50 can be moved into and out of the shell 10, as well as onto other horizontal surfaces such as tables, countertops and refrigerator shelves without loss of liquid.

In one embodiment, the male end of the non-gravity mounted coupling 50 is connected and disconnected to the female end of the non-gravity mounted coupling 40 by a movable ring- clamp 140 with a spring loaded push button 130 located on the connecting end of the female end of the non-gravity mounted coupling 40. The male end of the non-gravity mounted coupling 50 when attached to the female end of the non-gravity mounted coupling 40 provides a mechanical locking connection preventing unintentional disconnect of the coupling mechanism when the pin 150 on the male end of the non-gravity coupling 50 attaches to the crosshairs 170 of the female end of the non-gravity coupling. The push button 130 located on the female end of the non-gravity mounted coupling 40 moves in the direction of the dotted line arrow in FIG. 5 and enables the movable ring-clamp 140 to move down, which opens the mouth 120 as to enable the female end of the non-gravity mounted coupling 40 to connect to the male end of the non-gravity mounted coupling 50. The movable ring-clamp 140 has a first position, which partially occludes the mouth of the female end of the coupling when the push button 130 is in an unengaged position. The movable ring-clamp 140 has a second position when the push button 130 is pressed, which opens the mouth 120 to allow the male end of the non-gravity mounted coupling 50 to connect to the female end of the coupling. When the spring loaded push button 130 is returned to an unengaged position, the movable ring-clamp 140 returns to its first position of partial occlusion and retains the lip 160, thus securing the two ends of the coupling together.

The female end of the non-gravity mounted coupling 40 provides pressure against the pin 150 at the coupling site on the male end of the non-gravity mounted coupling 50, which in a first position is biased to a closed position, but when in a second position and connected, creates a liquid tight barrier and with pressure from the crosshairs 170 on the pin 150, allows a flow of liquid through the coupling without leakage from the coupling into the shell 10.

The female end of the non-gravity mounted coupling 40 which is opposite of the end that attaches to the male end of the non-gravity mounted coupling 50 is sized to be threaded through the opening of the first conduit 60 that connects the interior of the shell 10 to the spigot 70 on the exterior of the shell 10. The spigot 70 is biased to a closed position prohibiting the flow of liquid until manually operated. The attachment of the female end of the non-gravity mounted coupling 40 to the first conduit 60 prohibits liquid from leaking from the shell 10.

Throughout this specification, it should be understood and appreciated that movable ring clamp and, the spring loaded push button are not the only means for securing a liquid tight seal with the two ends of the non-gravity mounted coupling.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A cooler comprising:
a shell which is insulated, said shell defining an interior apart from an exterior and comprising a bottom, at least one sidewall, a movable top and a first conduit extending through an opening in the sidewall from the interior to the exterior, said first conduit being connected at the exterior end to a spigot for dispensing liquid and at its interior end being connected to a female end of a non-gravity mounted coupling, and
a reservoir for liquid defining an inside apart from an outside and comprising a bottom, at least one sidewall, a top with a lid, and an opening that enables connection of a male end of the non-gravity mounted coupling attached to a second conduit which extends from the outside of the reservoir,
such that when the female end and male end of the non-gravity mounted coupling are secured together there is formed a liquid tight seal and a user may dispense liquid from the spigot.

2. The cooler as in claim 1, wherein the bottom of the reservoir is substantially flat.

3. The cooler as in claim 1, wherein the reservoir can be decoupled and removed from the shell

4. The cooler as in claim 2, wherein the substantially flat bottom of the reservoir enables the reservoir to rest on a flat surface when the reservoir is decoupled from the shell.

5. The cooler as in claim 1, wherein the non-gravity mounted coupling comprises a spring loaded pin near the end of the male end and a movable ring clamp near the female end which prevents leakage after decoupling.

6. The cooler as in claim 1, wherein the movable ring-clamp can be actuated by a push button.

7. The cooler as in claim 1, wherein the spigot can be removed from the exterior of the shell and then attached to the end of the second conduit outside the reservoir, such that the reservoir can be used as a separate liquid dispenser when not connected to the shell.

8. The cooler as in claim 1, wherein the spigot comprises threading and is attached to the exterior end of the first conduit which also comprises threading.

9. The cooler as in claim 8, wherein the outside end of the second conduit comprises threading, and the spigot can be attached to the second conduit by means of threading.

10. The push button as in claim 6, wherein when in a first and unengaged position, the movable ring-clamp does not allow for insertion of the male end of the non-gravity mounted coupling.

11. The push button as in claim 6, wherein when in a second and engaged position, the movable ring-clamp is forced down to enlarge the mouth of the female end of the non-gravity mounted coupling to a circumference larger than the end of male end of the non-gravity mounted coupling.

12. The push button as in claim 2, wherein the male end of the non-gravity mounted coupling is inserted into the female end of the non-gravity mounted coupling, the spring loaded push button returns to the unengaged position, forcing the movable ring-clamp back in place creating the mechanical locking connection.

13. The cooler as in claim 1, where the female end of the non-gravity mounted coupling, when connected to the male end of the non-gravity mounted coupling provides pressure against a spring loaded pin located at a point of connection on the female end of the non-gravity mounted coupling that when in a first position is bias to a closed position, but that when in a second position and connected to the male end of the non-gravity mounted coupling, allows a flow of liquid through the coupling.

14. The conduit as in claim 3, wherein the female end of the non-gravity mounted coupling attaches to the conduit by threading and the conduit extends from the interior of the shell to the exterior of the shell where it connects to the spigot.

15. The spigot as in claim 3, remains in a closed position prohibiting the flow of liquid until manually operated.
